(19) United States
(12) Patent Application Publication
(10) Pub. No.: US 2015/0068956 A1
(43) Pub. Date: Mar. 12, 2015

(54) METHOD AND APPARATUS FOR SEPARATION OF MOLYBDENITE FROM PYRITE CONTAINING COPPER-MOLYBDENUM ORES

(71) Applicants: Gennady Nikolaevich Mashevskiy, St. Petersburg (RU); Rodrigo Grau, Pori (FI); Mikko Lyyra, Pori (FI); Aleksandr Vladimirovich Petrov, St. Petersburg (RU)

(72) Inventors: Gennady Nikolaevich Mashevskiy, St. Petersburg (RU); Rodrigo Grau, Pori (FI); Mikko Lyyra, Pori (FI); Aleksandr Vladimirovich Petrov, St. Petersburg (RU)

(73) Assignee: OUTOTEC (FINLAND) OY, Espoo (FI)

(21) Appl. No.: 14/399,468

(22) PCT Filed: May 10, 2012
(86) PCT No.: PCT/RU2012/000399

§ 371 Date: Nov. 6, 2014

(51) Int. Cl. B03D 1/002; B03D 1/02

(52) U.S. Cl. CPC B03D 1/002; B03D 1/02
USPC 209/162

(57) ABSTRACT

A method and an apparatus for the separation of the mineral components of a pyrite containing copper-molybdenum ore by flotation. The method comprises grinding the ore in the presence of soda ash in an open circuit to produce an aqueous ore slurry; subjecting the slurry to a collective flash flotation step (10) in the presence of soda ash and sodium sulphide to recover a first part of metal sulphides of the ore in the form of a first concentrate (C1); subjecting the tailings (T1) of the collective flash flotation step (10) to a grinding step (13) and to a collective rougher flotation step (14) to recover a second part of metal sulphides of the ore in the form of a second concentrate (C3); and subjecting the concentrate (C1) of the collective flash flotation step (10) and the concentrate (C3) of the collective rougher flotation step (14) to a selection step (12) to separate molybdenite from the other metal sulphides of the concentrate.

### FIELD OF THE INVENTION

The present invention relates to a method for the separation of the mineral components of pyrite containing copper-molybdenum ores by flotation. The invention also relates to an apparatus to be used in implementing such method.

### BACKGROUND OF THE INVENTION

Most of the economically significant base metal ore deposits worldwide contain mixed sulphides. Molybdenite, which is the most important source of molybdenum, occurs usually in low concentration along with other metal sulphide minerals, such as copper and/or iron bearing minerals. Conventional methods for beneficiation of such ores involve either bulk flotation of metal sulphides, followed by the separation of the desired metal sulphide, or selective flotation of the desired metal sulphide, depending on individual ore characteristics.

Table 1 shows the ore compositions of six exploited or prospected copper-molybdenum deposits located in the Eastern Europe or Asia. Pyrite (FeS₂) and silicates (feldspar, quartz, muscovite, sericite, biotite, chlorites) are common constituents in base metal ores. The presence of pyrites in flotation is undesirable because they are generally difficult to depress and normally require a highly alkaline medium.

In conventional flotation systems for copper ores with recoverable molybdenum by-product values, the ore is first crushed and ground in the presence of lime, which is usually added to depress pyrite. The ore is then treated in a primary flotation circuit after copper collector and frother have been added. The copper rougher concentrate thus obtained contains most of the copper and a substantial portion of the molybdenum. This copper rougher concentrate is then subjected to several stages of cleaner flotation, usually after a regrind operation, to produce a finished copper concentrate. This concentrate contains substantially all of the molybdenite recovered in the rougher circuit. The copper concentrate is then treated in a series of separation steps to separate the molybdenite as a high-purity concentrate.

TABLE 1

| | A | B | C | D | E | F |
|---|---|---|---|---|---|---|
| CuFeS₂ | 0.3 | 0.3 | 1.2 | 1.0 | 0.02 | 1.0 |
| FeS₂ | 2.8 | 2.0 | 3.0 | 0.5 | 2.0 | 0.7 |
| MoS₂ | 0.1 | 0.1 | 0.1 | | 0.25 | 0.05 |
| Quartz | 33 | 24 | 30 | 20 | 30 | 27.5 |
| Feldspar | 37 | 44 | 35 | 0.1 | 30 | 22 |
| Muscovite | 25 | 20 | 27 | 18 | 11 | 40 |
| Sericite | | | | | | |
| Biotite | | | | | | |
| Chlorites | | | | | | |
| Carbonates | 0.2 | 6.5 | 1.5 | 1.8 | 2.0 | 5 |
| Fe hydro- | 0.1 | + | 0.3 | 1.1 | 1.0 | 3 |
| gen oxides | | | | | | |
| Mo | 0.07 | 0.068 | 0.019 | 0.003 | 0.072 | 0.006 |
| S | 0.71 | 0.78 | 2.5 | 0.80 | 0.52 | 0.82 |
| Pb | 0.008 | 0.016 | + | 0.01 | 0.037 | 0.002 |
| Zn | 0.009 | 0.020 | + | 0.012 | 0.067 | 0.004 |
| Fe | 2.2 | 3.0 | 2.5 | 6.4 | 3.32 | 3 |
| Cu | 0.057 | 0.05 | 0.55 | 0.47 | 0.02 | 0.4 |

Flowsheets comprising selective flotation in the presence of lime are common in the world practice of concentrating pyrite containing copper-molybdenum ores. Flotation in the presence of lime is also applied in process flowsheets comprising preliminary production of collective copper-molybdenum concentrate. Examples of processes comprising collective flotation of two or more metals in an open cycle in alkaline medium created by lime are disclosed for instance in patent documents RU 2397816 C1 and RU 2398635 C1.

Poor copper-molybdenum ores contain commonly 20% or more sericite, which is a microcrystalline variety of muscovite, a mineral belonging to the mica subfamily of sheet silicates. It has been proved that flotation activity of sericite in a lime environment is increased when the slurry pH is increased. Consequently, high sericite content in the ore hampers the production of high-grade molybdenum concentrate containing over 53% molybdenum. The increased flotation activity of sericite is not taken into consideration in the presently implemented lime-based processing methods of poor copper-molybdenum ores.

It is also known that lime depresses molybdenite in a separation flotation phase. The presence of iron hydroxides in copper-molybdenum ores and the presence of corrosion films of hydroxycompounds on the surfaces of molybdenite and other sulphide minerals are further unfavorable factors during the processing of copper-molybdenum ores in the presence of lime.

Still another unfavorable factor in processing of copper-molybdenum ores is related to the strong sliming property of molybdenite during the primary grinding stage when aiming at satisfactory fiberation of molybdenite from host rock and other sulphide minerals. Non-floating micron-sized mineral particles can be produced during the primary grinding. It is also worth mentioning that during the primary grinding to an optimum liberation grind size, overgrinding of soft sericite rocks takes place as well, promoting the increase of their natural floatability.

U.S. Pat. No. 4,606,817 A discloses a process for recovering molybdenite from an ore that contains molybdenite along with at least one other metal sulphide. Also here lime is used for pH adjustment. The process comprises floating molybdenite from a comparatively coarsely ground pulp of molybdenite ore using only a small amount of frother but no collector to produce a molybdenite concentrate essentially devoid of collector contamination. The concentrate is cleaned, after possible regrinding, in a cleaning circuit while the tailing from the collectorless flotation operation is subjected to bulk sulphide flotation to yield a bulk sulphide concentrate which is then worked up to recover remaining molybdenite and other sulphide values contained in the ore. The above discussed problems related to the use of lime in flotation cannot be avoided in this process.

The object of the present invention is to eliminate the drawbacks of prior art and to provide an improved method for the separation of the mineral components of pyrite containing copper-molybdenum ores by flotation.

### SUMMARY OF THE INVENTION

The method for the separation of the mineral components of copper-molybdenum ores comprises the following steps: grinding the ore in the presence of soda ash in an open circuit to produce an aqueous slurry of ore; subjecting the slurry to a collective flash flotation step in the presence of soda ash and sodium sulphide to separate a first part of metal sulphide minerals of the ore in the form of a first concentrate; subjecting the tailings of the collective flash flotation step to a grinding step and a collective rougher flotation step to separate a second part of metal sulphide minerals of the ore in the form of a second concentrate; and subjecting the concentrate of the collective flash flotation step and the concentrate of the collective rougher flotation step to a selection step to separate molybdenite from the other metal sulphide minerals of the concentrate.

The inventors have observed that soda ash (sodium carbonate, Na₂CO₃) is the most efficient pH regulator in primary flash flotation of pyrite-containing copper-molybdenum ores. The efficiency of soda ash can be further intensified by adding a small amount of sodium sulphide (Na₂S) in the ore slurry. The other reagents used in the flash flotation step comprise frothers, such as pine oil, and collectors, such as fuel oil and various xanthates.

The process may further comprise the steps of measuring the reduction potential Eh and the pH of the slurry during the collective flash flotation step and adjusting the addition of soda ash and/or sodium sulphide to the slurry based on said measurement to maintain the Eh-pH relationship of the slurry in an optimum range. Preferably, the fine tuning of the Eh-pH-relationship is carried out by adjusting the addition of sodium sulphide to the slurry.

Preferably, the relationship between Eh and pH is maintained in the area of:

Eh=E⁰−59 pH, (1)

where E⁰=437 . . . 457, for the following reaction:

CuFeS₂+5H₂O═Cu(OH)₂+Fe(OH)₃+2S⁰+5H⁺+5e⁻.

The concentrate of the collective flash flotation step may be subjected to a cleaning flotation step before the selective flotation step. The tailings from the cleaning flotation step may be processed together with the tailings of the collective flash flotation step.

The tailings of the collective flash flotation step may be subjected to regrinding to reach a particle size more suitable for rougher flotation before the tailings are subjected to the collective rougher flotation step.

The concentrate of the collective rougher flotation step may be passed to a cleaning circuit, after which the cleaned concentrate is passed to the selection step together with the concentrate of the collective flash flotation step. The aim of the cleaning circuit is to remove the remaining gangue minerals from the metal sulphide minerals.

According to an advantageous embodiment of the present invention, the concentration of sulphide ions in the selection step is measured by Ag₂S-electrode potential and the addition of sodium sulphide into the selection step is controlled based on the measured potential to maintain the Ag₂S-electrode potential within a desired range. In one embodiment of the present, a suitable range for the Ag₂S-electrode potential would be from −660 mV to −710 mV.

The apparatus according to the present invention comprises:
an open grinding circuit for grinding the ore in the presence of soda ash to produce an aqueous slurry of ore;
a first flotation circuit for a collective flash flotation of the slurry in the presence of soda ash and sodium sulphide to recover a first part of metal sulphide minerals of the ore in the form of a first concentrate;
a grinding circuit for grinding the tailings of the first flotation circuit;
a second flotation circuit for a collective rougher flotation of the ground tailings to recover a second part of metal sulphide minerals of the ore in the form of a second concentrate; and
a selection circuit for processing the first concentrate and the second concentrate to separate molybdenite from the other metal sulphide minerals of the concentrates.

### BRIEF DESCRIPTION OF THE DRAWINGS

The accompanying drawings illustrate embodiments of the invention and together with the description help to explain the principles of the invention. In the drawings:

FIG. 1 is a process flowsheet illustrating the principle of the minerals separation process according to the present invention.

FIG. 2 is a diagram showing Cu₂S electrode potential vs. Ag₂S electrode potential, modeling depression of sulphide minerals in the selection step.

FIG. 3 is a diagram showing molybdenum recovery into the concentrate versus molybdenum content in the concentrate when using different reagent modes in collective flash flotation step.

FIG. 4 is a diagram showing a trend in searching optimum correlation between the measured pH and Eh parameters during pilot plant testing.

### DETAILED DESCRIPTION OF THE INVENTION

In ore beneficiation, flotation is a process in which valuable minerals are separated from worthless material or other valuable minerals by inducing them to gather in and on the surface of a froth layer. The process is based on the ability of certain chemicals to modify the surface properties of the minerals. Other chemicals are used to generate the froth and still others are used to adjust the pH. Certain chemicals are even capable of depressing the flotation of minerals that are either to be recovered at a later time or are not to be recovered.

The floatability of a mineral mainly depends on its ability to adhere to air bubbles. Mineral particles that get readily attached to air bubbles are water repellent or hydrophobic, those that do not attach are hydrophilic.

More or less polar minerals, such as most sulphides, must be conditioned by chemical reagents before they can be recovered by flotation. A collector is a chemical that attaches to the mineral surface and produces a hydrophobic surface. While certain minerals are naturally hydrophobic and do not require a collector, recovery is often improved when a collector is used. Many different chemicals can be used as collectors, such as hydrocarbon oils (e.g. fuel oil) and sulfhydryl collectors (xanthates and dithiophosphates). Hydrocarbon oils are often used to float naturally hydrophobic minerals, such as molybdenite, and xanthates are often used to float other sulphide minerals.

Frothers are compounds that act to stabilize air bubbles so that the bubbles will remain well-dispersed in the slurry and form a stable froth layer that can be removed before the bubbles burst. The most commonly used frothers include pine oil, certain alcohols, and low molecular weight polypropylene glycols.

Modifiers are chemicals that influence the way that collectors attach to mineral surfaces. They may increase the adsorption of a collector onto a given mineral (activators), or prevent a collector from adsorbing onto a mineral (depressants).

The simplest modifiers are pH control chemicals. The surface chemistry of most minerals is affected by the pH. In conjunction with an appropriate xanthate collector, sufficient alkali will depress almost any sulphide mineral and for any concentration of a particular collector, there is a pH value below which any given mineral will float and above which it will not float. This allows the operator to selectively float various sulphide minerals from an ore slurry. The critical pH value of any ore depends on the nature of the mineral, the particular collector, its concentration and the temperature. These factors correlate with the reduction potential (Eh) of the slurry. Therefore, it is possible to define the optimal operational area of a flotation process by means of Eh-pH diagram (Pourbaix diagram), which shows the thermodynamic stability of different species in an aqueous solution.

In a method according to the present invention, soda ash is used as a pH modifier to adjust the pH of the slurry and to decrease the flotation of pyrite. The effect of soda ash is further improved by addition of a small amount of sodium sulphide. By controlling the addition of soda ash and/or sodium sulphide it is possible to run the flotation process in an Eh-pH area which is optimal for flotation of chalcopyrite (CuFeS₂) and optimal for depression of pyrite (FeS₂).

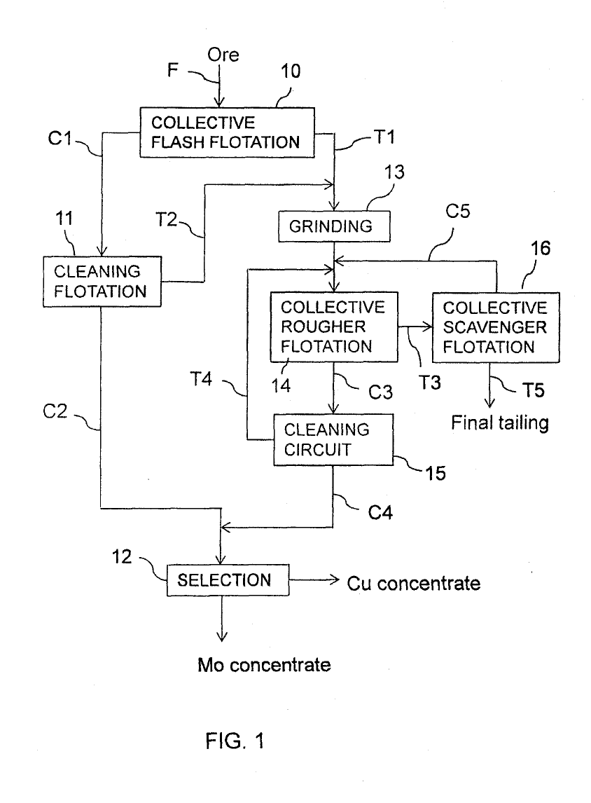

FIG. 1 illustrates a flowsheet of a copper-molybdenum ore separation scheme according to the present invention. In accordance of the present invention, the ore is first crushed and ground in the presence of soda ash in an open circuit to form an aqueous ore slurry with a relatively coarse grain size. A suitable grain size is estimated to be below 5 mm, preferably below 4 mm, but the optimal size should be separately determined for every deposit, depending on the size of free molybdenite grains.

The ore slurry F resulting from the grinding step is subjected to a collective flash flotation step 10 carried out in flash flotation cells, agitating the slurry and introducing air as small bubbles. Small amounts of soda ash, sodium sulphide, frothers and collectors are added to the slurry, either before or during the collective flash flotation step 10. Preferable collectors comprise fuel oil and xanthates, but also other hydrocarbon oils and sulfhydryl collectors may be used. A flash flotation process, by definition, involves a relatively short flotation time. In the method according to the present invention the flotation time in the collective flash flotation step 10 may be as short as 1-2 minutes.

The ability of a mineral to float depends upon its surface properties. Chemical modification of these properties enables the mineral particles to attach to an air bubble in the flotation cell. The air bubble and mineral particle rise through the slurry to the surface of the froth which is present in the flotation cell. The mineral froth (concentrate) is physically separated from the remaining slurry material (tailings) and removed for further processing.

Concentrate C1 of the collective flash flotation step 10 contains a first part of the metal sulphide minerals of the ore. Under favorable conditions, this first concentrate C1 contains over 50% of the molybdenum of the ore, over 50% of the copper of the ore, over 90% of the sulphides of the slurry and under 20% of the iron of the ore. Advantageously, over 53% of the molybdenite of the ore can be recovered in the collective flash flotation step 10. At the same Lime, only a minor part of gangue minerals of the ore is carried into the first concentrate C1.

The first concentrate C1 from the collective flash flotation step 10 is passed to a cleaning flotation step 11 to separate the remaining gangue minerals from the metal sulphide minerals. Cleaned concentrate C2 from the cleaning flotation step 11 is passed to a selection step 12, in which molybdenite (MoS₂) is selectively separated from the other metal sulphides of the ore. Tailings T2 of the cleaning flotation step 11 are combined with tailings T1 of the collective flash flotation step 10.

The tailings T1 of the collective flash flotation step 10 and the tailings T2 of the cleaning flotation step 11 are subjected to a grinding step 13, in which the average particle size is reduced to allow separation of the rest of the metal sulphide minerals of the ore from the gangue minerals in a subsequent collective rougher flotation step 14. Concentrate C3 of the collective rougher flotation step 14 contains a second part of the metal sulphide minerals of the ore.

The concentrate C3 of the collective rougher flotation step 14 is passed to a cleaning circuit 15 which may comprise, for instance, three cascading flotation cleaning steps. Cleaned concentrate C4 received from the cleaning circuit 15 is passed to the selection step 12 together with the cleaned concentrate C2 of the collective flash flotation step 10. Tailings T4 of the cleaning circuit 15 are recycled back to the feed of the collective rougher flotation step 14.

Tailings T3 of the collective rougher flotation step 14 are passed to a collective scavenger flotation step 16, from which a concentrate C5 is recycled back to the feed of the collective rougher flotation step 14. Tailings T5 of the collective scavenger flotation step 16 are removed from the ore beneficiation process.

The selection step 12 comprises separation of molybdenite from the other metal sulphide minerals, such as copper sulphide and pyrite. Advantage is taken of the strong natural floatability of MoS₂. When xanthate is used as a bulk collector in the collective flash flotation step 10, desorption of the collector from the copper mineral surface can be achieved by addition of sodium sulphide. Addition of Na₂S to the selection step 12 is controlled in order to optimize the separation of molybdenite from the other metal sulphides of the slurry. Advantageously, the Ag₂S-electrode potential of the slurry is maintained in the range from −660 mV to −710 mV during the selection step 12.

The main purpose of collective flash flotation of coarsely ground ore is to ensure maximum recovery of free big grains of molybdenite and molybdenite associated with other sulphide minerals or soft rock sericites. This purpose is achieved by using sodium sulphide (Na₂S) as an additional activator besides soda ash, and by combined use of fuel oil and xanthate as collectors. Advisability of such combination of reagents is proved by the test results to be discussed in connection with Example 1.

Flotation separation of pyrite containing copper-molybdenum ores is usually performed at an alkaline pH. In the present invention, sodium carbonate (soda ash) is used as a pH modifier instead of lime. Addition of Na₂S has been verified to increase the recovery of molybdenum associated with non-activated pyrite. Xanthate acts as a collector that attaches to the mineral surface and produces a hydrophobic surface.

The water-repellent film thus formed facilitates the attachment of the mineral particle to an air bubble. Fuel oil improves the flotation of molybdenite.

The collective flash flotation step 10 may be implemented using Outotec SkimAir® flotation units. Outotec TankCell® flotation units may be used in the subsequent flotation and cleaning steps 11, 12, 14, 15, 16. The grinding step 13 may be implemented using a conventional ball mill.

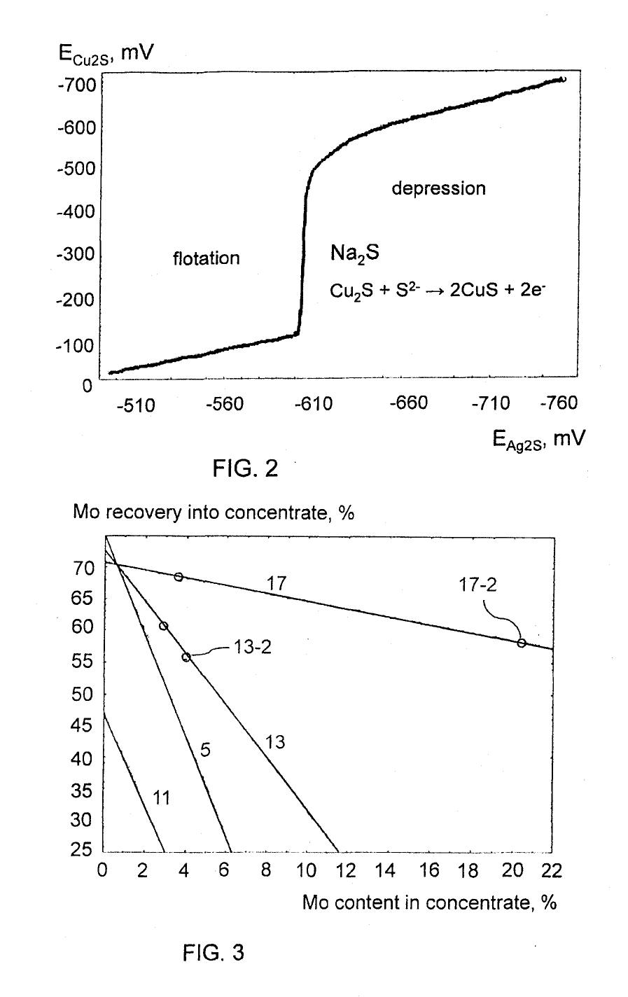

Selection of pure sulphide concentrates in the presence of sodium sulphide does not present a problem and is based on keeping a thermodynamic leap during which the surface of sulphide minerals gains a large negative potential and becomes hydrophilous. FIG. 2 illustrates modeling of the process of molybdenite selection from other sulphide minerals by their depression in Na₂S environment. More precisely, FIG. 2 shows the electrode potential of a monocrystalline Cu₂S-electrode vs. the electrode potential of an Ag₂S-electrode, whereby the curve models desorption of Na₂S. According to the presented model, in order to ensure full depression of copper sulphide minerals in the selection step, it is advisable to maintain the concentration of sulphide ions, as determined by Ag₂S electrode, at a level ranging from −660 mV to −710 mV during the selection step 12.

According to one embodiment of the present method, reduction potential and slurry pH are measured in connection with the collective flash flotation step 10 and the dosage of soda ash and/or sodium sulphide in the collective flash flotation step 10 is controlled based on the measurement to keep the Eh-pH relationship in said flotation step 10 in an optimum area.

It is estimated that implementing the proposed method for processing ore from deposit A of Table 1 would ensure 95% molybdenum recovery in the collective circuit with 4% of molybdenum in the collective flash flotation concentrate. Further conditioning of the collective flash flotation concentrate in the selection circuit would produce final molybdenum concentrate containing 53% of molybdenum and 85% of absolute metal recovery from ore.

Next, the invention will be further illustrated by way of the following examples.

### Example 1

Four collective flash flotation tests were carried out in laboratory scale with an ore body originating from deposit A of Table 1 and with four different combinations of reagents. The reagents used in the tests are shown in Table 2.

TABLE 2

| Test | Reagents used in flash |
|---|---|
| No. | flotation |
| 5 | Na₂CO₃ + fuel oil + |
| | xanthate |
| 11 | Na₂CO₃ + fuel oil + Na₂S |
| 13 | Na₂CO₃ + fuel oil + Na₂S + |
| | xanthate |
| 17 | Na₂CO₃ + fuel oil |

The results of the flash flotation tests are shown in Table 3. The values in each column illustrate the recovery of each chemical element (Cu, Fe, Mo, S) in the flash flotation concentrate as the percentage by weight of the element's original content in the ore body. The last column illustrates the sulphide content of the concentrate.

TABLE 3

| Test No | Cu % | Fe % | Mo % | S % | Sulphides % |
|---|---|---|---|---|---|
| 5 | 52.4 | 15.2 | 47 | 54 | 91.8 |
| 11 | 8.2 | 13.8 | 27.4 | 51 | 91.7 |
| 13 | 52 | 17.8 | 56.11 | 61.2 | 91.6 |
| 17 | 40 | 0.8 | 58.2 | 5.1 | 60.6 |

In Tests 5 and 13, which involve using Na₂CO₃, fuel oil and xanthate, the recovery of copper was the best. In Test 13, which involves additionally using Na₂S, the recovery of iron (pyrite) was the highest, whereas in Test 17, with no collectors, it was the lowest. The molybdenum content of the concentrate was the highest in Tests 13 and 17. On the other hand, the sulphide content of the concentrate in Test 17 was the lowest, which indicates that the concentrate contains a high percentage of gangue minerals.

FIG. 3 shows the percentage of molybdenum recovered into the concentrate versus the molybdenum content in the concentrate. Tests 13-2 and 17-2 are almost equal in terms of molybdenum recovery, but Test 17-2 shows a substantially higher amount of produced concentrate in terms of molybdenum content in it. Based on Table 2, it may look like the result of Test 17 would deserve attention, but this conclusion is erroneous. In the produced concentrate, sulphides are replaced with sericites, which eventually prevents production of high-grade molybdenum concentrate with high molybdenum content in it in the subsequent selection step.

The metal sulphide contents of the concentrates of Tests 5, 11 and 13 are on the same level whereas the metal sulphide content of the concentrate of Test 17 is significantly lower. This indicates that a collective flash flotation step carried out without Na₂S and xanthate as collectors is less selective than a similar step carried out with Na₂S and/or xanthate.

Test 5 indicates somewhat lower molybdenum recovery than Test 13. This is probably due to the absence of sodium sulphide in the collective flash flotation process and insufficient recovery of molybdenum associated with non-activated pyrite.

In Test 11, relatively low molybdenum recovery was achieved because of the absence of xanthate in the collective flash flotation process and because of insufficient recovery of copper and pyrite.

The results of other tests demonstrate that in case additional collectors—xanthate and Na₂S activator—are used, an almost pure sulphide concentrate without sericite impurities can be produced, which ensures production of high-grade molybdenum concentrate with as high as 53% molybdenum content in it with further selection. Selection of pure sulphide concentrates in the presence of sodium sulphide does not present a problem and is based on keeping a thermodynamic leap during which the surface of sulphide minerals gains a large negative potential and becomes hydrophilic.

### Example 2

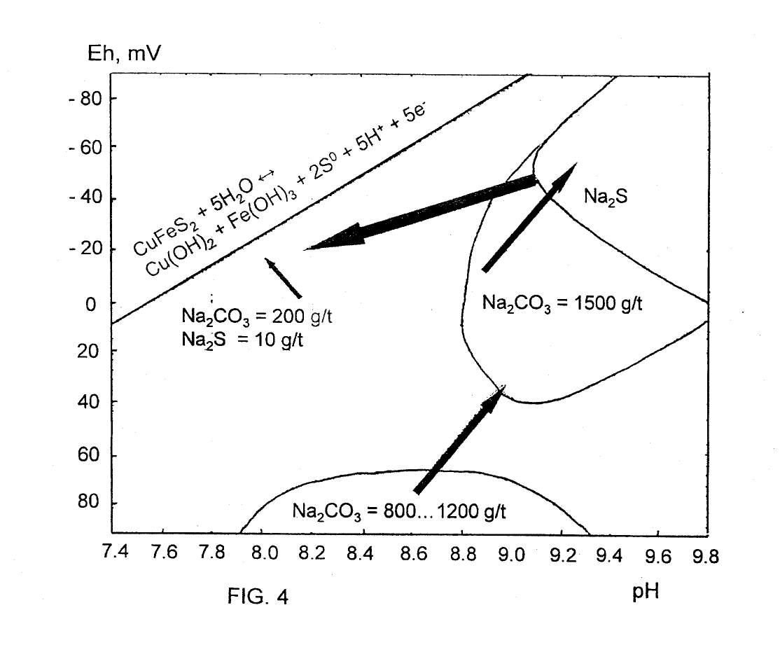

Optimum dosage of soda ash and sodium sulphide in the collective flash flotation step was checked in terms of conformity to the new method during pilot tests. Different conditions of slurry preparation are illustrated in FIG. 4, where arrows indicate the sequence of tested conditions, comprising first addition of Na₂CO₃ in amounts of 800 g/t, 1200 g/t and 1500 g/t and then addition of a small amount of Na₂S together with Na₂CO₃. Finally, a combination of g/t of Na₂S together with 200 g/t of Na₂CO₃ was tested. In connection with the tested conditions, the reduction potential (Eh vs. SHE) and pH of the slurry were measured. The tests indicated that good results could be achieved by using a combination of 10 g/t of Na₂S together with 200 g/t of Na₂CO₃.

It was found out that an optimum dosage of soda ash and sodium sulphide could be reached when the relationship between Eh and pH was in the following area:

Eh=E⁰−59 pH, (1)

where E⁰=437 . . . 457, for the following reaction:

CuFeS₂+5H₂O═Cu(OH)₂+Fe(OH)₃+2S⁰+5H⁺+5e⁻.

In FIG. 4, the optimum area for chalcopyrite (CuFeS₂) to become sufficiently hydrophobic to float is in close proximity to the line indicating the Eh-pH relationship of the above reaction. In the optimum area, the reduction potential Eh is from −80 to 10 mV and the pH is from 7.4 to 9.1.

It is obvious that the Eh-pH relationship depends on several factors, which is why the optimum relationship should be defined for each case separately. This example proves, however, that the dosage of soda ash and sodium sulphide in the flash flotation step can be optimized by monitoring the Eh and pH of the slurry and by adjusting the addition of soda ash and/or sodium sulphide based on the measured values.

It is obvious to a person skilled in the art that with the advancement of technology, the basic idea of the invention may be implemented in various ways. The invention and its embodiments are thus not limited to the examples described above; instead they may vary within the scope of the claims.

1. A method for the separation of the mineral components of pyrite containing copper-molybdenum ores by flotation, the method comprising the steps of:
a) grinding the ore in the presence of soda ash in an open circuit to produce an aqueous slurry of ore;
b) subjecting the slurry to a collective flash flotation step in the presence of soda ash and sodium sulphide to recover a first part of metal sulphide minerals of the ore in the form of a first concentrate;
c) subjecting the tailings of the collective flash flotation step to a grinding step and to a collective rougher flotation step to recover a second part of metal sulphide minerals of the ore in the form of a second concentrate; and
d) subjecting the concentrate of the collective flash flotation step and the concentrate of the collective rougher flotation step to a selection step to separate molybdenite from the other metal sulphide minerals of the concentrate.

2. A method according to claim 1, further comprising the steps of measuring the reduction potential Eh and pH of the slurry in the collective flash flotation step and adjusting the addition of soda ash and/or sodium sulphide to the slurry based on said measurements in order to maintain the Eh-pH relationship of the slurry in an optimum range in the collective flash flotation step.

3. A method according to claim 2, wherein the relationship between Eh and pH is maintained in the area of:
Eh=E⁰−59 pH,
where E⁰=437 . . . 457, for the following reaction:
CuFeS₂+5H2₀═Cu(OH)₂+Fe(OH)₃+2S⁰+5H⁺+5e⁻.

4. A method according to claim 2, wherein the fine tuning of the Eh-pH relationship is carried out by controlling an addition of sodium sulphide to the slurry before or during the collective flash flotation step.

5. A method according to claim 1, wherein the concentrate of the collective flash flotation step is subjected to a cleaning flotation step before being passed to the selective flotation step.

6. A method according to claim 1, wherein the concentrate of the collective rougher flotation step is subjected to a cleaning circuit before passing the cleaned rougher concentrate to the selection step together with the concentrate of the collective flash flotation step.

7. A method according to claim 6, wherein the tailings of the collective rougher flotation step are passed to a collective scavenger flotation step.

8. A method according to claim 1, wherein the sulphide ion concentration of the slurry in the selection step is measured using an Ag₂S-electrode and the addition of sodium sulphide in connection with the selection step is controlled based on the measured Ag₂S-electrode potential to maintain the Ag₂S-electrode potential in a desired range.

9. A method according to claim 8, wherein the Ag₂S-electrode potential of the slurry is maintained in the range from −660 mV to −710 mV.

10. A method according claim 1, wherein hydrocarbon oils and sulfhydryl collectors, such as xanthates, are used as collectors.

11. A method according claim 1, wherein the average grain size of the ore subjected to the flash flotation step is less than 5 mm.

12. An apparatus for the separation of the mineral components of pyrite containing copper-molybdenum ores by flotation, the apparatus comprising:
an open grinding circuit for grinding the ore in the presence of soda ash to produce an aqueous ore slurry;
a first flotation circuit for a collective flash flotation of the slurry in the presence of soda ash and sodium sulphide to recover a first part of metal sulphide minerals of the ore in the form of a first concentrate;
a grinding circuit for grinding the tailings of the first flotation circuit;
a second flotation circuit for a collective rougher flotation of the ground tailings to recover a second part of metal sulphide minerals of the ore in the form of a second concentrate; and
a selection circuit for processing the first concentrate and the second concentrate to separate molybdenite from the other metal sulphide minerals of the concentrates.

13. An apparatus according to claim 12, further comprising at least one instrument together capable of measuring the reduction potential Eh and the pH of the slurry in the collective flash flotation step and capable of adjusting an addition of at least one of soda ash and/of sodium sulphide to the slurry to maintain the Eh-pH relationship of the slurry in an optimum range in the collective flash flotation step.

14. An apparatus according to claim 12, comprising at least one instrument together capable of measuring the Ag₂S-electrode potential of the slurry in the selection circuit and capable of adjusting an addition of sodium sulphide to maintain the Ag₂S-electrode potential in the range from −660 mV to −710 mV.
